(19) United States
(12) Patent Application Publication
(10) Pub. No.: US 2026/0122522 A1
(43) Pub. Date: Apr. 30, 2026

(54) METHOD AND APPARATUS FOR SENDING CONFIGURATION INFORMATION, AND DEVICE AND MEDIUM

(71) Applicant: Beijing Xiaomi Mobile Software Co., Ltd., Beijing (CN)

(72) Inventor: Yi XIONG, Beijing (CN)

(73) Assignee: Beijing Xiaomi Mobile Software Co., Ltd., Beijing (CN)

(21) Appl. No.: 19/117,019

(22) PCT Filed: Sep. 29, 2022
(86) PCT No.: PCT/CN2022/122881

§ 371 Date: Mar. 28, 2025

(51) Int. Cl. H04W 24/10

(52) U.S. Cl. CPC H04W 24/10

(57) ABSTRACT

A processing method for an event includes: determining that a configuration parameter corresponding to a trigger event is changed, and making a trigger function of the trigger event invalid.

### CROSS-REFERENCE TO RELATED APPLICATIONS

The present application is a U.S. National Stage of International Application No. PCT/CN2022/122881, filed on Sep. 29, 2022, the disclosure of which is incorporated herein by reference in its entirety for all purposes.

### TECHNICAL FIELD

The present disclosure relates to the field of wireless communication technology, and in particular to a method for sending configuration information for an event and processing method and apparatus, a device, and a readable storage medium.

### BACKGROUND

In the new radio (NR) of the 5th generation mobile networks (5G), in order to support mobility of user equipment (UE) and obtain channel conditions of cells around the UE in a timely manner, the network device can indicate the UE to perform Radio Resource Management (RRM) measurements. The UE in an idle state or UE in an inactive state autonomously performs cell selection or cell reselection based on results of the RRM measurements. The UE in the connected state reports the RRM measurement results to the network to assist the network device in making handover decisions. During the measurement process of the connected-state UE, the network device sends measurement configuration information to the connected-state UE through Radio Resource Control (RRC) signaling. The UE performs co-frequency, inter-frequency or inter-system (RAT) measurements based on the measurement configuration information and reports the measurement results.

### SUMMARY

The present disclosure provides a method for sending configuration information for an event and processing method and apparatus, a device, and a readable storage medium.

In a first aspect, it provides a processing method for an event, which is performed by a user equipment, and the method includes:
determining that a parameter corresponding to a trigger event configuration is changed, and disabling a trigger function of the trigger event.

In a second aspect, it provides a method for sending configuration information, which is performed by a network device, and the method includes: sending configuration information to a user equipment, where the configuration information is used to configure parameters of a trigger event configuration.

In a third aspect, it provides a processing apparatus for an event, which is configured on a user equipment, and the apparatus includes: a processing module, configured to: determine that a parameter corresponding to a trigger event configuration is changed, and disable a trigger function of the trigger event.

In a fourth aspect, it provides a processing apparatus for an event, which is configured on a network device, and the apparatus includes: a transceiving module, configured to send configuration information to a user equipment, where the configuration information is used to configure parameters of a trigger event configuration.

In a fifth aspect, it provides an electronic device including a processor and a memory, where: the memory is configured to store a computer program; and the processor is configured to execute the computer program to implement the first aspect or any possible design of the first aspect.

In a sixth aspect, it provides an electronic device, including a processor and a memory, where: the memory is configured to store a computer program; and the processor is configured to execute the computer program to implement the second aspect or any possible design of the second aspect.

In a seventh aspect, it provides a computer-readable storage medium which stores instructions, and the instructions, when being called and executed on a computer, cause the computer to perform the above first aspect or any possible design of the first aspect.

In an eighth aspect, it provides a computer-readable storage medium which stores instructions, and the instructions, when being called and executed on a computer, cause the computer to perform the above second aspect or any possible design of the second aspect.

In a ninth aspect, it provides a communication system, the communication system includes a user equipment configured to perform the first aspect or any possible design of the first aspect and a network device configured to perform the second aspect or any possible design of the second aspect.

It is to be understood that the foregoing general description and the following detailed description are illustrative and explanatory only and are not restrictive of the present disclosure.

### BRIEF DESCRIPTION OF THE DRAWINGS

The accompanying drawings herein are incorporated in and constitute a part of the specification, illustrate embodiments consistent with the embodiments of the present disclosure, and together with the description, serve to explain the principles of the embodiments of the present disclosure.

FIG. 1 is a schematic diagram of an architecture of a wireless communication system provided by an embodiment of the present disclosure.

FIG. 2 is a flow chart of a processing method for an event provided by an embodiment of the present disclosure.

FIG. 3 is a flow chart of a processing method for an event provided by an embodiment of the present disclosure.

FIG. 4 is a flow chart of a processing method for an event provided by an embodiment of the present disclosure.

FIG. 5 is a structural diagram of a processing apparatus for an event provided by an embodiment of the present disclosure.

FIG. 6 is a structural diagram of another processing apparatus for an event provided by an embodiment of the present disclosure.

FIG. 7 is a structural diagram of an apparatus for sending configuration information provided by an embodiment of the present disclosure.

FIG. 8 is a structural diagram of another apparatus for sending configuration information provided by an embodiment of the present disclosure.

### DETAILED DESCRIPTION

The embodiments of the present disclosure are now further described in conjunction with the accompanying drawings and specific implementations.

Illustrative embodiments will be described in detail herein, examples of which are shown in the accompanying drawings. When the following description refers to the drawings, the same numbers in different drawings represent the same or similar elements unless otherwise indicated. The implementations described in the following illustrative embodiments do not represent all implementations consistent with the embodiments of the present disclosure. Instead, they are merely examples of devices and methods consistent with some aspects of the present disclosure as detailed in the appended claims.

The terms used in the embodiments of the present disclosure are only for the purpose of describing specific embodiments and are not intended to limit the embodiments of the present disclosure. The singular forms of “a” and “the” used in the embodiments of the present disclosure and the appended claims are also intended to include plural forms unless the context clearly indicates otherwise. It should also be understood that the term “and/or” used herein refers to and includes any or all possible combinations of one or more associated listed items.

It should be understood that although the terms first, second, third, etc. may be used to describe various information in the embodiments of the present disclosure, these information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the words “if” and “in a case where” as used herein may be interpreted as “when” or “at the time of”or “in response to determining”.

The embodiments of the present disclosure are described in detail below, and examples of the embodiments are shown in the accompanying drawings, where the same or similar reference numerals throughout represent the same or similar elements. The embodiments described below with reference to the accompanying drawings are illustrative and are intended to be used to explain the present disclosure, and cannot be understood as limiting the present disclosure.

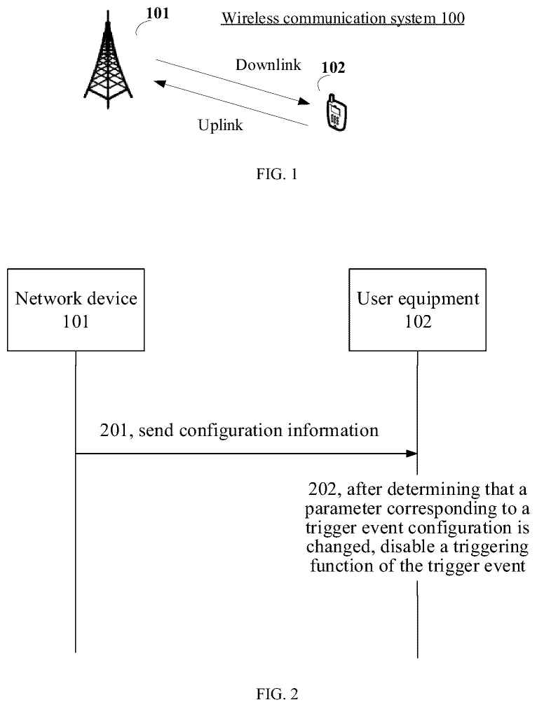

As shown in FIG. 1, a processing method for an event provided by the embodiments of the present disclosure may be applied to a wireless communication system 100, which may include a user equipment 102 and a network device 101. The user equipment 102 is configured to support carrier aggregation and may be connected to multiple carrier components of the network device 101, including a primary carrier component and one or more secondary carrier components.

It should be understood that the above wireless communication system 100 can be applied to both low-frequency scenarios and high-frequency scenarios. The application scenarios of the wireless communication system 100 include, but are not limited to, a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5-th generation (5G) system, a new radio (NR) communication system, a future evolved public land mobile network (PLMN) system, or the like.

The user equipment 102 shown above may be a terminal, an access user device, a user device unit, a user device station, a mobile station (MS), a remote station, a remote user device, a mobile user device (mobile terminal), a wireless communication device, a user device agent, a user device, or the like. The user equipment 102 may have a wireless transceiving function, and can perform communication (such as wireless communication) with one or more network devices of one or more communication systems and receive network services provided by the network devices, and the network devices here include but are not limited to the illustrated network device 101.

The user equipment 102 may be a cellular phone, a cordless phone, a session initiation protocol (SIP) phone, a wireless local loop (WLL) station, a personal digital assistant (PDA) device, a handheld device with wireless communication function, a computing device or other processing device connected to a wireless modem, a vehicle-mounted device, a wearable device, a user equipment in a future 5G network, a user equipment in a future evolved PLMN network, or the like.

The network device 101 may be an access network device (or referred to as an access network station). The access network device refers to a device that provides network access functions, such as a radio access network (RAN) base station, etc. The network device 101 may specifically include a base station (BS), or a base station and a radio resource management device for controlling the base station, etc. The network device 101 may also include a relay station (relay device), an access point, a base station in a future 5G network, a base station in a future evolved PLMN network, an NR base station, or the like. The network device 101 may be a wearable device or a vehicle-mounted device. The network device 101 may also be a communication chip with a communication module.

For example, the network device 101 includes, but is not limited to: a next-generation base station (gnodeB, gNB) in 5G, an evolved node B (eNB) in an LTE system, a radio network controller (RNC), a node B (NB) in a WCDMA system, a radio controller in a CRAN system, a base station controller (BSC), a base transceiver station (BTS) in a GSM system or a CDMA system, a home base station (for example, home evolved nodeB, or home node B, HNB), a baseband unit (BBU), a transmitting and receiving point (TRP), a transmitting point (TP) or a mobile switching center, etc.

The RRM measurements involve three aspects: measurement configuration, measurement performing and measurement reporting. The content of the measurement report includes the following aspects.
1. Measurement identity. Through this identity, the network obtains various information from the measurement configuration stored in itself, including a measurement object corresponding to the current report, a measurement event threshold triggered by the event, the purpose of the periodic trigger, etc.
2. Measurement results of all available serving cells.
3. The best neighboring cell measurement result on various service frequency points, which can be optionally carried according to the reporting configuration.
4. Neighboring cell measurement results that fulfill a trigger condition.

In terms of measurement reporting, the user equipment may perform corresponding reporting after determining that a measurement reporting event is fulfilled. Since all or part of parameters of the measurement reporting event may be changed, the change of the parameters may affect the reporting.

Considering that all or part of the parameters of the trigger event may be changed, the change of the parameters may affect the operation corresponding to the trigger event.

Example 1: A trigger event is a measurement reporting event for RRM measurement. After the UE determines that the measurement reporting event is fulfilled, one or more RRM parameters of the measurement reporting event are changed in the process of reporting the measurement results. After the one or more RRM parameters are changed, the current situation of the UE cannot fulfill this measurement reporting event, but the UE will continue to perform the operation of reporting the measurement results until the reporting is completed, which will cause the measurement results received by the network device to be inaccurate.

Example 2: A trigger event is a measurement reporting event for RRM measurement. One or more RRM parameters of the measurement event are changed at the same time when or within a short time period after the UE determines that the measurement reporting event is fulfilled. After the one or more RRM parameters are changed, the current situation of the UE cannot fulfill this measurement event, but the UE will subsequently start to perform the operation of reporting the measurement results, which will cause the measurement results received by the network device to be inaccurate.

Example 3: A trigger event is a trigger event for conditional reconfiguration. After the UE determines that this trigger event is fulfilled, one or more RRM parameters of this trigger event are changed. After the one or more RRM parameters are changed, the current situation of the UE cannot fulfill this trigger event, which may result in triggering an erroneous conditional reconfiguration, thereby causing the UE to access an inappropriate cell.

The embodiments of the present disclosure provide a processing method for an event. FIG. 2 is a flow chart of a processing method for an event according to an illustrative embodiment. As shown in FIG. 2, the method includes steps 201 to 202, specifically as below.

In step 201, a network device sends configuration information to a user equipment.

The configuration information is used to configure parameters corresponding to a trigger event configuration. After receiving the configuration information from the network device, the user equipment can learn about the trigger event and use the trigger event.

In step 202, after determining that a parameter corresponding to the trigger event configuration is changed, the user equipment disables a triggering function of the trigger event.

In some implementations, the user equipment actively modifies the parameter corresponding to the trigger event configuration, resulting in the parameter corresponding to the trigger event configuration being changed.

In some implementations, the trigger event may be a measurement reporting event for RRM measurement.

For example, the trigger event is the following intra-RAT measurement event supported by the NR system:
Event A1: a serving cell measurement result is greater than a threshold;
Event A2: a serving cell measurement result is less than a threshold;
Event A3: a neighboring cell measurement result is better than a SpCell (which can be PCell or PSCell) measurement result;
Event A4: a neighboring cell measurement result is greater than a threshold;
Event A5: a SpCell (which can be a PCell or a PSCell) measurement result is less than threshold 1, and the neighboring cell measurement result is greater than threshold 2; or
Event A6: a neighbor cell measurement result is better than a certain secondary serving cell (SCell) measurement result.

For another example, the trigger event is the following inter-RAT measurement event supported by the NR system:
Event B1: an inter-RAT neighboring cell measurement result is greater than a threshold; or
Event B2: a primary serving cell (PCell) measurement result is less than threshold 1, and an inter-RAT neighboring cell measurement result is greater than threshold 2.

For another example, in a case where the user equipment is an unmanned aerial vehicle, the trigger event is an event based on an altitude of the user equipment supported by the NR system:
Event H1: an altitude of the UE in the air is higher than a threshold; or
Event H2: an altitude of the UE in the air is lower than a threshold.

Alternatively, it is an event based on the mobility of the user equipment, such as an event based on the speed of the user equipment, an event based on the vertical speed of the user equipment, etc.

In some implementations, the parameter corresponding to the trigger event configuration being changed includes at least one of the following:
1. The parameters of the trigger event configuration increase or decrease.

For example, a trigger event configuration corresponds to N parameters, one or more parameters are added to the trigger event configuration, or one or more parameters are removed from the N parameters.
2. At least one parameter of the trigger event configuration changes.

For example, a value of a parameter of the trigger event configuration is X, and the value of this parameter is changed to Y, where Y is different from X.

For another example, a parameter of the trigger event configuration is increased by an offset,
a parameter of the trigger event configuration is reduced by an offset,
a parameter of the trigger event configuration is multiplied by a scaling amount, or
a parameter of the trigger event configuration is divided by a scaling amount.

Alternatively, for example, a specific value of a parameter of the configuration changes from a preset value to a value different from the preset value, the specific value of the parameter of the configuration changes from a value different from the preset value to the preset value, or the specific value of the parameter of the configuration changes from one preset value to another preset value; where the preset value is a fixed value pre-configured by the network device for the user equipment.

In a case where the trigger event is a measurement reporting event, the parameter of the configuration includes at least one of the following:
time to trigger (the time to trigger is time for performing triggering according to setting of the trigger event),
a threshold value used for determining whether the trigger event is fulfilled,
the number of reporting the result corresponding to the trigger event, or
an interval for reporting the result corresponding to the trigger event.

In some implementations, disabling the trigger function of the trigger event includes at least one of the following:
1. stopping a reporting operation corresponding to the trigger event;
2. not performing the reporting operation corresponding to the trigger event; or
3. setting a state corresponding to the trigger event as being not fulfilled.

In a case where the trigger event is a measurement reporting event, the reporting operation corresponding to the trigger event includes at least one of the following: stopping a periodic reporting timer corresponding to measurement identity of the trigger event; performing a reporting operation corresponding to the trigger event for one time when it is determined that preset indication information is configured, where the preset indication information is used to indicate whether to perform the reporting operation corresponding to the trigger event for one time when the configuration corresponding to the trigger event is changed;
deleting a measurement reporting entry corresponding to the measurement identity, or
deleting all or part of cells in a trigger cell list corresponding to the measurement identity,
where the measurement identity is a corresponding measurement identity in a UE variable (VarMeasReportList) storing a measurement report list.

The operation 1 mentioned above is applicable to the situation where the parameter corresponding to the trigger event configuration is changed during the process of performing the reporting operation of the trigger event by the UE. For example, in the case of the above example 1, the trigger event is a measurement reporting event. After the UE determines that the measurement reporting event is fulfilled, one or more RRM parameters of this measurement reporting event are changed in the process of reporting the measurement results. After the one or more RRM parameters are changed, the current situation of the UE cannot fulfill this measurement reporting event. In this case, the UE stops performing the operation of reporting the measurement results, thereby avoiding inaccurate measurement results received by the network device.

The operation 2 mentioned above is applicable to the situation where one or more RRM parameters of the trigger event are changed at the same time when or within a short time period after the UE determines that the trigger event is fulfilled. For example, in the case of the above example 2, the trigger event is a measurement reporting event, and one or more RRM parameters of the measurement event are changed at the same time when or within a short time period after the UE determines that the measurement reporting event is fulfilled. After the one or more RRM parameters are changed, the current situation of the UE cannot fulfill this measurement event. In this case, the UE does not perform the operation of reporting the measurement result, thereby avoiding inaccurate measurement results received by the network device.

The operation 3 mentioned above is applicable to the situation where one or more RRM parameters of a trigger event are changed after it is determined that the trigger event is fulfilled. For example, in the case of above example 3, the trigger event is a trigger event for conditional reconfiguration. After the UE determines that the trigger event is fulfilled, one or more RRM parameters of the trigger event are changed. After the one or more RRM parameters are changed, the current situation of the UE cannot fulfill the trigger event. In this case, the UE sets the state corresponding to the trigger event as being not fulfilled, which can be understood as changing the state corresponding to the trigger event from being met to being not fulfilled, thereby avoiding from triggering an erroneous conditional reconfiguration, and preventing the UE from accessing an inappropriate cell.

The operation 3 is applicable to the situation where the trigger event is a conditional reconfiguration event and the conditional reconfiguration event is associated with a measurement identity. In an example, the measurement identity is a measurement identity included in VarMeasConfig associated with condReconfigId in condExecutionCond or condExecutionCondSCG.

It can also be described as that for each conditional reconfiguration identity (condReconfigId) in the UE variable (VarConditionalReconfig) storing the conditional reconfiguration, for each measId contained in VarMeasConfig associated with condReconfigId in condExecutionCond or condExecutionCondSCG, if the parameter value of the event associated with this measId is changed, the state corresponding to the event associated with this measurement identity is set as being not fulfilled.

In the embodiments of the present disclosure, after determining that the parameter corresponding to the trigger event configuration is changed, the trigger function of the trigger event is disabled and the original operation corresponding to the trigger event is no longer performed, thereby preventing inaccurate or inappropriate processing caused by the change of the parameter of the configuration.

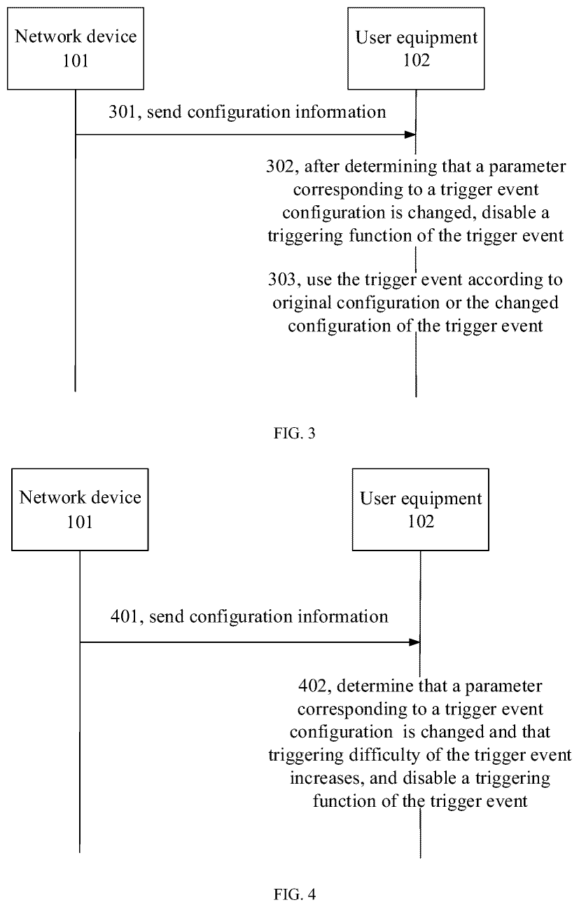

An embodiment of the present disclosure provides a processing method for an event. FIG. 3 is a flow chart of a processing method for an event according to an illustrative embodiment. As shown in FIG. 3, the method includes steps 301 to 303, specifically as below.

Step 301 is the same as step 201, and step 302 is the same as step 202, which will not be repeated here.

In step 303, the trigger event is used according to original configuration or the changed configuration of the trigger event.

In some implementations, using the trigger event according to the original configuration or the changed configuration of the trigger event includes one of the following:
when the user equipment fulfills a condition, using the trigger event according to the original configuration of the trigger event;
when the user equipment fulfills a condition, using the trigger event according to the changed configuration of the trigger event;
when the user equipment does not fulfill a condition, using the trigger event according to the original configuration of the trigger event; or
when the user equipment does not fulfill a condition, using the trigger event according to the changed configuration of the trigger event.

In some implementations, the condition is one or more of the following:
the user equipment is a low-speed user equipment, the user equipment is a medium-speed user equipment the user equipment is a high-speed user equipment;
a speed of the user equipment is greater than a first speed threshold value, where the first speed threshold value is configured by a network device or specified by a protocol;
the speed of the user equipment is less than a second speed threshold value, where the second speed threshold value is configured by a network device or specified by a protocol;
an altitude of the user equipment is higher than a first altitude threshold value, where the first altitude threshold value is configured by a network device or specified by a protocol;
the altitude of the user equipment is lower than a second altitude threshold value, where the second altitude threshold value is configured by a network device or specified by a protocol;
or the user equipment fulfills at least one set event or at least one set condition.

In some implementations, the configuration corresponding to the trigger event being changed includes: in response to that the user equipment changes from satisfying a condition to not satisfying the condition, the configuration corresponding to the trigger event being changed.

An embodiment of the present disclosure provides a processing method for an event. FIG. 4 is a flow chart of a processing method for an event according to an illustrative embodiment. As shown in FIG. 4, the method includes steps 401 to 402, specifically as below.

In step 401, a network device sends configuration information to a user equipment.

The configuration information is used to configure parameters corresponding to a trigger event configuration. After receiving the configuration information from the network device, the user equipment learns the trigger event and uses the trigger event.

In step 402, the user equipment determines that a parameter corresponding to the trigger event configuration is changed and that triggering difficulty of the trigger event increases, and disables a triggering function of the trigger event.

In some implementations, the user equipment actively modifies the parameter corresponding to the trigger event configuration, resulting in the parameter corresponding to the trigger event configuration being changed.

In some implementations, the step 402 further includes: determining whether the triggering difficulty of the trigger event increases according to the changed parameter of the configuration.

In an example, the parameter of the configuration being changed is time to trigger (TTT), and whether the triggering difficulty of the trigger event increases is determined according to whether the parameter of the configuration after change is greater than or less than the parameter of the configuration before the change. If the parameter of the configuration being changed is the time to trigger, when the changed time to trigger is greater than the time to trigger before the change, it is determined that the triggering difficulty of the trigger event increases; if the parameter of the configuration being changed is the time to trigger, when the changed time to trigger is less than the time to trigger before the change, it is determined that the triggering difficulty of the trigger event decreases.

For example, if the TTT value before the change is 1 second and the TTT value after the change is 2 seconds, it is determined that the trigger event is more difficult to be fulfilled, and the triggering difficulty of the trigger event increases.

For another example, if the value of TTT before change is 1 second and the value of TTT after the change is 0.5 second, it is determined that the trigger event is easier to be fulfilled and the triggering difficulty of the trigger event decreases.

In another example, the type of the changed parameter is a threshold value, and whether the triggering difficulty of the trigger event increases is determined according to whether the parameter of the configuration being changed is greater than or less than the parameter of the configuration before the change. If the parameter of the configuration being changed is a threshold value, when the changed threshold value is greater than the threshold value before the change, it is determined that the triggering difficulty of the trigger event increases; and if the parameter of the configuration being changed is a threshold value, when the changed threshold value is less than the threshold value before the change, it is determined that the triggering difficulty of the trigger event decreases.

For example, if the threshold value before change is 10 seconds and the threshold value after change is 8 seconds, it is determined that the trigger event is easier to be fulfilled and the triggering difficulty of the trigger event is reduced.

For another example, if the threshold value before change is 10 seconds and the threshold value after change is 12 seconds, it is determined that the trigger event is more difficult to be fulfilled, and the triggering difficulty of the trigger event increases.

In another example, when the parameter of the configuration being changed is a reporting interval, it has no impact on the triggering difficulty of the trigger event, and it is determined that the triggering difficulty of the trigger event remains unchanged.

How to compare the triggering difficulty of the trigger event before and after the change is determined by the user equipment.

An embodiment of the present disclosure provides a processing method for an event, which is performed by a user equipment. The method is directed to a measurement reporting event, and the method includes: if a parameter of a measurement reporting event is changed, stopping execution of a subsequent measurement reporting process.

An embodiment of the present disclosure provides a processing method for an event, which is performed by a user equipment. The method is directed to a conditional reconfiguration event, and the method includes: if a parameter of a conditional reconfiguration event is changed, setting the conditional reconfiguration event as being not fulfilled. Alternatively, it can be described as: if a parameter of a conditional reconfiguration event is changed, setting to not satisfy the conditional reconfiguration event.

An embodiment of the present disclosure provides a processing method for an event, which is performed by a user equipment. The method is directed to a measurement reporting event, and the method includes: if a parameter of a measurement reporting event is changed and the changed measurement reporting event becomes more difficult to be fulfilled, stopping execution of a subsequent measurement reporting process.

An embodiment of the present disclosure provides a processing method for an event, which is performed by a user equipment. The method is directed to a measurement reporting event, and the method includes: if a parameter of a measurement reporting event is changed, and the changed measurement reporting event becomes easier to be fulfilled, continuing to execute the subsequent measurement reporting process.

An embodiment of the present disclosure provides a processing method for an event, which is performed by a user equipment. The method is directed to a conditional reconfiguration event, and the method includes: if a parameter of a conditional reconfiguration event is changed, and the changed conditional reconfiguration event becomes more difficult to be fulfilled, setting the conditional reconfiguration event as being not fulfilled. Alternatively, it can be described as: if a parameter of a conditional reconfiguration event is changed, and the changed conditional reconfiguration event becomes more difficult to be fulfilled, setting to not satisfy the conditional reconfiguration event.

An embodiment of the present disclosure provides a processing method for an event, which is performed by a user equipment. The method is directed to a conditional reconfiguration event, and the method includes: if a parameter of a conditional reconfiguration event is changed, and the changed conditional reconfiguration event becomes easier to be fulfilled, not resetting a state of the conditional reconfiguration event. Alternatively, it is described as: if a parameter of a conditional reconfiguration event is changed, and the changed conditional reconfiguration event becomes easier to be fulfilled, maintaining the state of the conditional reconfiguration event.

An embodiment of the present disclosure provides a processing method for an event, which is performed by a user equipment, and the method includes: when one or more parameter values of a configured measurement reporting event are changed, stopping execution of a subsequent measurement reporting process. Alternatively, when one or more parameter values of a configured measurement reporting event are changed, comparing difficulty of satisfying the measurement reporting event before the change and difficulty of satisfying the measurement reporting event after the change, if it is more difficult to be fulfilled after the change, stopping the subsequent measurement reporting process, and if it is easier to be fulfilled after the change, continuing the subsequent measurement reporting process.

In some implementations, stopping execution of the subsequent measurement reporting process includes:
deleting a measurement report entry corresponding to the corresponding measurement ID in the UE variable (VarMeasReportList) storing a measurement report list;
sopping a periodic reporting timer corresponding to the corresponding measurement ID;
deleting all or part of cells in a trigger cell list corresponding to the corresponding measurement ID in the UE variable (VarMeasReportList) storing the measurement report list; and
if preset indication information is configured, initiating reporting once, where the preset indication information is used to indicate whether the reporting needs to be performed when a parameter is changed.

In some implementations, the parameter value being changed includes at least one of the following:
the parameter value is adjusted, that is, changed from a value configured by a network to the adjusted value; or
the parameter value is restored, i.e., changed from the adjusted value to the original value configured by the network.

In some implementations, the parameter value includes at least one of the following: time to trigger (TTT), one or more threshold values corresponding to the event, the number of reporting, and a reporting interval.

In some implementations, the method further includes: if the user equipment fulfills a condition, using the adjusted parameter value for the corresponding event; if the user equipment does not fulfill the condition, using the unadjusted parameter value for the corresponding event.

The condition may be configured by the network device, may be specified by a protocol, or may be determined according to the UE implementation requirements.

In some implementations, the condition is one or more of the following:
the user equipment is a low-speed user equipment, the user equipment is a medium-speed user equipment,
the user equipment is a high-speed user equipment;
   a speed of the user equipment is greater than a first speed threshold value, where the first threshold value is configured by a network device or specified by a protocol; the speed of the user equipment is less than a second speed threshold value, an altitude of the user equipment is higher than a first altitude threshold value, where the second threshold value is configured by a network device or specified by a protocol; the altitude of the user equipment is lower than a second altitude threshold value, or the user equipment fulfills at least one set event (e.g., event H1, event H2) or at least one set condition.

In some implementations, that the UE fulfills the condition or changes from satisfying the condition to not satisfying the condition causes the parameter value to be changed, and thus the method includes one of the following: in response to the UE satisfying a first criterion, the UE stops executing a subsequent measurement reporting process;
in response to the UE changing from satisfying the first criterion to not satisfying the first criterion, the UE stops executing the subsequent measurement reporting process;
in response to the UE satisfying the first criterion, comparing difficulty of satisfying the event before the change and difficulty of satisfying the event after the change, if it is more difficult to satisfy the event after the change, stopping the subsequent measurement reporting process, otherwise continuing the subsequent measurement reporting process; or
in response to the UE changing from satisfying the first criterion to not satisfying the first criterion, comparing the difficulty of satisfying the event before the change and difficulty of satisfying the event after the change, if it is more difficult to satisfy the event after the change, stopping the subsequent measurement reporting process, otherwise continuing the subsequent measurement reporting process.

In some implementations, the changed parameter value may be determined according to a network configuration or according to a protocol specification.

In some implementations, the parameter value of at least one parameter of the event configuration being changed includes at least one of the following:
the parameter value of at least one parameter of the trigger event configuration is increased by an offset,
the parameter value of at least one parameter of the trigger event configuration is reduced by an offset,
the parameter value of at least one parameter of the trigger event configuration is multiplied by a scaling amount, or
the parameter value of at least one parameter of the trigger event configuration is divided by a scaling amount.

Alternatively, for example, the parameter value changes from a configured value to a value different from the configured value, the parameter value changes from a value different from the configured value to the configured value, or the parameter value changes from one configured value to another configured value; where the configured value is a value configured by the network device for the user equipment.

In some implementations, the method further includes: determining whether triggering difficulty of the trigger event increases according to a type of the changed parameter and the changed parameter value in the changed configuration.

In an example, the type of the changed parameter is time to trigger (TTT), and whether the triggering difficulty of the trigger event increases is determined according to whether the parameter value after the change is greater than or less than the parameter value before the change.

For example, if the TTT value before the change is 1 second and the TTT value after the change is 2 seconds, it is determined that the trigger event is more difficult to be fulfilled, and the triggering difficulty of the trigger event increases.

For another example, if the TTT value before the change is 1 second and the value of TTT after the change is 0.5 second, it is determined that the trigger event is easier to be fulfilled and the triggering difficulty of the trigger event decreases.

In another example, the type of the changed parameter is a threshold value, and whether the triggering difficulty of the trigger event increases is determined according to whether the parameter value after the change is greater than or less than the parameter value before the change.

For example, if the threshold value before the change is 10 seconds and the threshold value after the change is 8 seconds, it is determined that the trigger event is easier to be fulfilled and the triggering difficulty of the trigger event decreases.

For another example, if the threshold value before the change is 10 seconds and the threshold value after the change is 12 seconds, it is determined that the trigger event is more difficult to be fulfilled, and the triggering difficulty of the trigger event increases.

In another example, when the type of the changed parameter is a reporting interval, it has no impact on the triggering difficulty of the trigger event, and it is determined that the triggering difficulty of the trigger event remains unchanged.

How to compare the triggering difficulty of the trigger event before and after the change is determined by the user equipment.

An embodiment of the present disclosure provides a processing method for an event, which is performed by a user equipment, and the method includes: when one or more parameter values of a configured conditional reconfiguration event are changed, determining that the conditional reconfiguration event as being not fulfilled. Alternatively, when one or more parameter values of a configured conditional reconfiguration event are changed, comparing difficulty of satisfying the conditional reconfiguration event before the change and difficulty of satisfying the conditional reconfiguration event after the change, if it is more difficult to be fulfilled after the change, stopping the subsequent measurement reporting process, and if it is easier to be fulfilled after the change, continuing the subsequent measurement reporting process.

In some implementations, when one or more parameter values of a configured conditional reconfiguration event associated with a measurement identity are changed, it is determined that the conditional reconfiguration event associated with a measurement identity as being not fulfilled.

For example, for each conditional reconfiguration identity (condReconfigId) in the UE variable (VarConditionalReconfig) storing the conditional reconfiguration, for each measId contained in the VarMeasConfig associated with the condReconfigId in the condExecutionCond or condExecutionCondSCG, if the parameter value of the event associated with this measId is changed, the event associated with this measurement identity is considered as being not fulfilled.

In some implementations, the parameter value being changed includes at least one of the following: the parameter value is adjusted, that is, changed from a value configured by a network to the adjusted value; or the parameter value is restored, i.e., changed from the adjusted value to the original value configured by the network.

In some implementations, the parameter value includes at least one of the following: time to trigger (TTT), one or more threshold values corresponding to the event, the number of reporting, and a reporting interval.

In some implementations, the method further includes: if the user equipment fulfills a condition, using the adjusted parameter value for the corresponding event; if the user equipment does not fulfill the condition, using the unadjusted parameter value for the corresponding event.

The first criterion may be configured by the network device, may be specified by a protocol, or may be determined according to the UE implementation requirements.

In some implementations, the condition is one or more of the following:
the user equipment is a low-speed user equipment,
the user equipment is a medium-speed user equipment,
the user equipment is a high-speed user equipment;
a speed of the user equipment is greater than a first speed threshold value, where the first speed threshold value is configured by a network device or specified by a protocol;
the speed of the user equipment is less than a second speed threshold value, where the second speed threshold value is configured by a network device or specified by a protocol;
an altitude of the user equipment is higher than a first altitude threshold value, where the first altitude threshold value is configured by a network device or specified by a protocol;
the altitude of the user equipment is lower than a second altitude threshold value, where the second altitude threshold value is configured by a network device or specified by a protocol;
or the user equipment fulfills at least one set event (e.g., event H1, event H2) or at least one set condition.

In some implementations, that the UE fulfills the condition or changes from satisfying the condition to not satisfying the condition causes the parameter value to be changed, and thus the method includes one of the following:

in response to the UE satisfying a criterion, determining the event as being not fulfilled;

in response to the UE changing from satisfying the criterion to not satisfying the criterion, determining the event as being not fulfilled;
in response to the UE satisfying the criterion, comparing difficulty of satisfying the event before the change and difficulty of satisfying the event after the change, if it is more difficult to satisfy the event after the change, determining the event as being not fulfilled; or
in response to the UE changing from satisfying the criterion to not satisfying the criterion, comparing the difficulty of satisfying the event before the change and difficulty of satisfying the event after the change, if it is more difficult to satisfy the event after the change, determining the event as being not fulfilled.

In some implementations, the parameter value after the change may be determined according to a network configuration or according to a protocol specification.

In some implementations, the parameter value of at least one parameter of the event configuration being changed includes at least one of the following:
the parameter value of at least one parameter of the trigger event configuration is increased by an offset,
the parameter value of at least one parameter of the trigger event configuration is reduced by an offset,
the parameter value of at least one parameter of the trigger event configuration is multiplied by a scaling amount, or
the parameter value of at least one parameter of the trigger event configuration is divided by a scaling amount.

Alternatively, for example, the parameter value changes from a configured value to a value different from the configured value, the parameter value changes from a value different from the configured value to the configured value, or the parameter value changes from one configured value to another configured value; where the configured value is a value configured by the network device for the user equipment.

In some implementations, the method further includes: determining whether the difficulty of satisfying the event increases according to the type of the changed parameter and the changed parameter value in the changed configuration.

In an example, the type of the changed parameter is time to trigger (TTT), and whether the difficulty of satisfying the event increases is determined according to whether the parameter value after the change is greater than or less than the parameter value before the change.

For example, if the TTT value before the change is 1 second and the TTT value after the change is 2 seconds, it is determined that the event is more difficult to be fulfilled and the triggering difficulty of the event increases.

For another example, if the TTT value before the change is 1 second and the TTT value after the change is 0.5 second, it is determined that the event is easier to be fulfilled and the triggering difficulty of the event decreases.

In another example, the type of the changed parameter is a threshold value, and whether the difficulty of satisfying the event increases is determined according to whether the parameter value after the change is greater than or less than the parameter value before the change.

For example, if the threshold value before the change is 10 seconds and the threshold value after the change is 8 seconds, it is determined that the event is easier to be fulfilled, and the difficulty of satisfying the trigger event decreases.

For another example, if the threshold value before the change is 10 seconds and the threshold value after the change is 12 seconds, it is determined that the event is more difficult to be fulfilled and the difficulty of satisfying the event increases.

In another example, when the type of the changed parameter is a reporting interval, it has no impact on the difficulty of satisfying the event, and it is determined that the difficulty of satisfying the event remains unchanged.

How to compare the difficulty of satisfying the event before and after the change is determined by the user equipment.

An embodiment of the present disclosure provides a processing method for an event, which is performed by a network device. The method includes: sending configuration information to a user equipment, where the configuration information is used to configure parameters of a trigger event configuration.

Based on the same concept as the above method embodiments, an embodiment of the present disclosure further provides a communication apparatus, which may have the functions of the user equipment 102 in the above method embodiments, and is configured to perform the steps performed by the user equipment 102 provided in the above embodiments. The functions may be implemented by hardware, or by software or hardware executing corresponding software. The hardware or software includes one or more modules corresponding to the above functions.

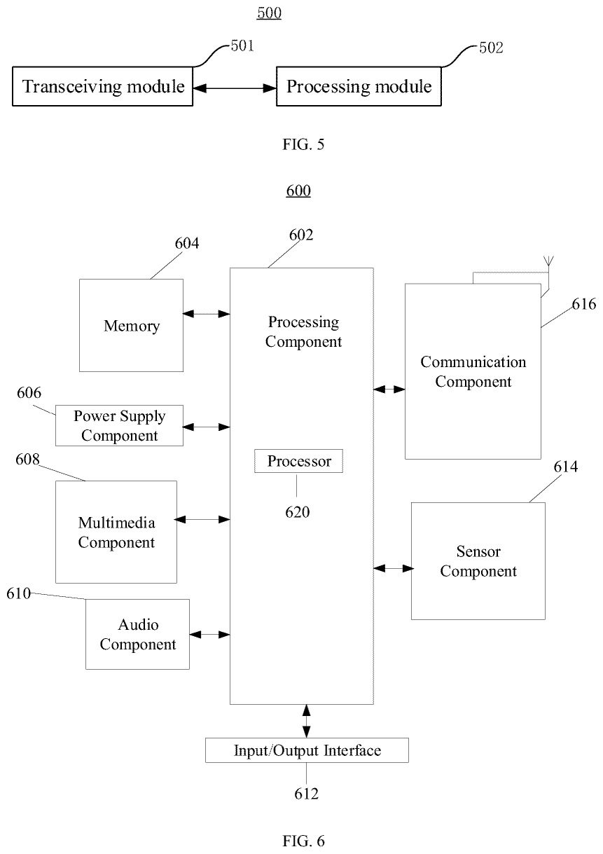

In an implementation, the communication apparatus 500 shown in FIG. 5 may serve as the user equipment 102 involved in the above method embodiments, and perform the steps performed by the user equipment 102 in the above method embodiments.

The communication apparatus 500 includes a processing module 502, or includes a transceiving module 501 and a processing module 502.

The processing module 502 is configured to determine that a parameter corresponding to a trigger event configuration is changed, and to disable a trigger function of the trigger event.

In some implementations, disabling the triggering function of the trigger event includes at least one of the following:
stopping a reporting operation corresponding to the trigger event;
not performing the reporting operation corresponding to the trigger event; or
setting a state corresponding to the trigger event as being not fulfilled.

In some implementations, the parameter corresponding to the trigger event configuration being changed includes at least one of the following:
the parameter of the configuration being increased by an offset,
the parameter of the configuration being reduced by an offset,
the parameter of the configuration being multiplied by a scaling amount, or
the parameter of the configuration being divided by a scaling amount.

In some implementations, the parameter of the configuration includes at least one of the following:
time to trigger; the time to trigger is time for performing the trigger according to setting of the trigger event;
a threshold value used to determine whether the trigger event is fulfilled; the number of reporting a result corresponding to the trigger event; or
an interval for reporting the result corresponding to the trigger event.

In some implementations, the trigger event is a measurement reporting event, and the reporting operation corresponding to the trigger event is at least one of the following:
stopping a periodic reporting timer corresponding to a measurement identity of the trigger event; performing the reporting operation corresponding to the trigger event for one time when it is determined that preset indication information is configured, where the preset indication information is used to indicate whether to perform the reporting operation corresponding to the trigger event once when the configuration corresponding to the trigger event is changed;
deleting a measurement reporting entry corresponding to the measurement identity; or
deleting all or part of cells in a trigger cell list corresponding to the measurement identity.

In some implementations, the trigger event is a conditional reconfiguration event, and the conditional reconfiguration event is associated with a measurement identity.

In some implementations, the processing module 502 is further configured to perform one or more of the following:
when the user equipment fulfills a condition, using the trigger event according to original configuration of the trigger event;
when the user equipment fulfills the condition, using the trigger event according to the changed configuration of the trigger event;
when the user equipment does not fulfill the condition, using the trigger event according to the original configuration of the trigger event; or
when the user equipment does not fulfill the condition, using the trigger event according to the changed configuration of the trigger event.

In some implementations, the condition is one or more of the following:
the user equipment is a low-speed user equipment,
the user equipment is a medium-speed user equipment;
the user equipment is a high-speed user equipment;
a speed of the user equipment is greater than a first speed threshold;
the speed of the user equipment is less than a second speed threshold;
an altitude of the user equipment is higher than a first altitude threshold;
the altitude of the user equipment is lower than a second altitude threshold; or
the user equipment fulfills at least one set event or at least one set condition.

In some implementations, the processing module 502 is further configured to: determine that triggering difficulty of the trigger event increases, and disable the triggering function of the trigger event.

In some implementations, the processing module 502 is further configured to: when the parameter of the configuration being changed is the time to trigger and the changed time to trigger is greater than the time to trigger before change, determine that the triggering difficulty of the trigger event increases. In some implementations, the processing module 502 is further configured to: when the parameter of the configuration being changed is the time to trigger and the changed time to trigger is greater than the time to trigger before change, determine that the triggering difficulty of the trigger event increases.

When the communication device is the user equipment 102, its structure may also be as shown in FIG. 6.

FIG. 6 is a block diagram of a processing apparatus for an event 600 according to an illustrative embodiment. For example, the apparatus 600 may be a mobile phone, a computer, a digital broadcast terminal, a messaging device, a game console, a tablet device, a medical device, a fitness device, a personal digital assistant, etc.

Referring to FIG. 6, the apparatus 600 may include one or more of the following components: a processing component 602, a memory 604, a power supply component 606, a multimedia component 608, an audio component 610, an input/output (I/O) interface 612, a sensor component 614, and a communication component 616.

The processing component 602 generally controls the overall operation of the apparatus 600, such as operations associated with display, phone calls, data communications, camera operations, and recording operations. The processing component 602 may include one or more processors 620 to execute instructions to perform all or part of the steps of the above methods. In addition, the processing component 602 may include one or more modules to facilitate interaction between the processing component 602 and other components. For example, the processing component 602 may include a multimedia module to facilitate interaction between the multimedia component 608 and the processing component 602.

The memory 604 is configured to store various types of data to support operations on the apparatus 600. Examples of such data include instructions for any application or method operating on the apparatus 600, contact data, phone book data, messages, pictures, videos, etc. The memory 604 can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply component 606 provides power to various components of the apparatus 600. The power supply component 606 may include a power management system, one or more power supplies, and other components associated with generating, managing, and distributing power for the apparatus 600.

The multimedia component 608 includes a screen that provides an output interface between the apparatus 600 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 608 includes a front camera and/or a rear camera. When the apparatus 600 is in an operating mode, such as a shooting mode or a video mode, the front camera and/or the rear camera may receive external multimedia data. The front camera and rear camera each may be a fixed optical lens system or have a focal length and optical zoom capability.

The audio component 610 is configured to output and/or input audio signals. For example, the audio component 610 includes a microphone (MIC), and when the apparatus 600 is in an operating mode, such as a call mode, a recording mode, and a speech recognition mode, the microphone is configured to receive an external audio signal. The received audio signal can be further stored in the memory 604 or sent via the communication component 616. In some embodiments, the audio component 610 also includes a speaker for outputting audio signals.

The I/O interface 612 provides an interface between processing component 602 and peripheral interface modules, such as a keyboard, a click wheel, buttons, etc. These buttons may include but are not limited to: a home button, a volume button, a start button, and a lock button.

The sensor component 614 includes one or more sensors for providing various aspects of status assessment for the apparatus 600. For example, the sensor component 614 can detect the open/closed state of the apparatus 600, the relative positioning of components, such as the display and keypad of the apparatus 600, and the sensor component 614 can also detect the position change of the apparatus 600 or a component of the apparatus 600, the presence or absence of user contact with the apparatus 600, the orientation or acceleration/deceleration of the apparatus 600, and the temperature change of the apparatus 600. The sensor component 614 may include a proximity sensor configured to detect the presence of a nearby object without any physical contact. The sensor component 614 may also include an optical sensor, such as a CMOS or CCD image sensor, for use in imaging applications. In some embodiments, the sensor component 614 may also include an accelerometer, a gyroscope sensor, a magnetic sensor, a pressure sensor, or a temperature sensor.

The communication component 616 is configured to facilitate wired or wireless communication between the apparatus 600 and other devices. The apparatus 600 can access a wireless network based on a communication standard, such as Wi-Fi, 4G or 5G, or a combination thereof. In an illustrative embodiment, the communication component 616 receives a broadcast signal or broadcast-related information from an external broadcast management system via a broadcast channel. In an illustrative embodiment, the communication component 616 also includes a near field communication (NFC) module to facilitate short-range communication. For example, the NFC module can be implemented based on a radio frequency identification (RFID) technology, an infrared data association (IrDA) technology, an ultra-wideband (UWB) technology, a Bluetooth (BT) technology and other technologies.

In an illustrative embodiment, the apparatus 600 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an illustrative embodiment, provided is a non-transitory computer-readable storage medium including instructions, such as a memory 604 including instructions, and the instructions can be executed by a processor 620 of the apparatus 600 to perform the above methods. For example, the non-transitory computer-readable storage medium can be a ROM, a random access memory (RAM), a CD-ROM, a magnetic tape, a floppy disk, an optical data storage device, etc.

Based on the same concept as the above method embodiments, an embodiment of the present disclosure also provides a communication apparatus, which can have the functions of the network device 101 in the above method embodiments, and is configured to perform the steps performed by the network device 101 provided in the above embodiments. The functions can be implemented by hardware, or by software or hardware executing corresponding software. The hardware or software includes one or more modules corresponding to the above functions.

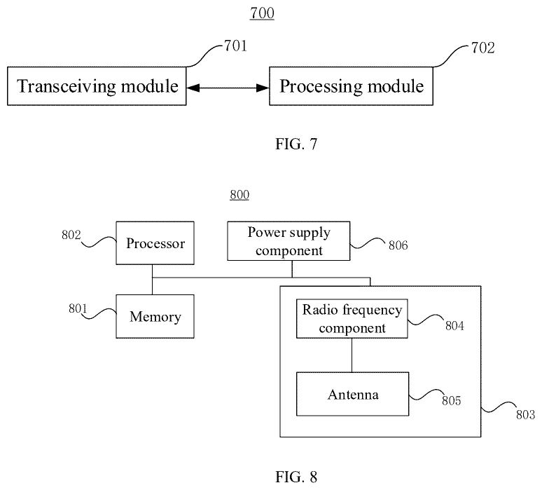

In an implementation, the communication apparatus 700 shown in FIG. 7 may be used as the network device 101 involved in the above method embodiments, and perform the steps performed by the network device 101 in the above method embodiments.

The communication apparatus 700 includes a transceiving module 701 and a processing module 702.

The transceiving module 701 is configured to send configuration information to a user equipment, where the configuration information is used to configure parameters corresponding to a trigger event configuration.

When the communication apparatus is the network device 101, its structure can also be shown in FIG. 8. The structure of the communication apparatus is described by taking an example in which the network device 101 is a base station. As shown in FIG. 8, the apparatus 800 includes a memory 801, a processor 802, a transceiving component 803, and a power supply component 806. The memory 801 is coupled to the processor 802, and can be configured to store programs and data necessary for the communication apparatus 800 to implement various functions. The processor 802 is configured to support the communication apparatus 800 to perform the corresponding functions in the above methods, and the functions can be implemented by calling the program stored in the memory 801. The transceiving component 803 can be a wireless transceiver, which can be configured to support the communication apparatus 800 to receive signaling and/or data and send signaling and/or data through a radio air interface. The transceiving component 803 may also be referred to as a transceiving unit or a communication unit. The transceiving component 803 may include a radio frequency component 804 and one or more antennas 805, where the radio frequency component 804 may be a remote radio unit (RRU), which may be specifically configured to transmit radio frequency signals and convert radio frequency signals into baseband signals, and the one or more antennas 805 may be specifically configured to radiate and receive radio frequency signals. When the communication apparatus 800 needs to send data, the processor 802 may perform baseband processing on the data to be sent, and then output the baseband signal to the radio frequency unit. The radio frequency unit performs radio frequency processing on the baseband signal and then sends the radio frequency signal through the antenna in the form of electromagnetic waves. When data is sent to the communication apparatus 800, the radio frequency unit receives the radio frequency signal through the antenna, converts the radio frequency signal into a baseband signal, and outputs the baseband signal to the processor 802. The processor 802 converts the baseband signal into data and processes the data.

Those skilled in the art will readily appreciate other implementations of the embodiments of the present disclosure after considering the specification and practicing the invention disclosed herein. The present disclosure is intended to cover any variations, uses, or adaptations of the embodiments of the present disclosure, which follow the general principles of the embodiments of the present disclosure and include common knowledge or customary technical means in the art that are not disclosed in the present disclosure. The specification and examples are to be considered as illustrative only, and the true scope and spirit of the embodiments of the present disclosure are indicated by the following claims.

It should be understood that the embodiments of the present disclosure are not limited to the precise structures described above and shown in the drawings, and various modifications and changes may be made without departing from the scope thereof. The scope of the embodiments of the present disclosure is limited only by the appended claims.

### INDUSTRIAL APPLICABILITY

After determining that the configuration corresponding to the trigger event is changed, the trigger function of the trigger event is disabled, and the original operation corresponding to the trigger event is no longer performed, thereby preventing inaccurate or inappropriate processing caused by the configuration changed.

1. A processing method for an event, performed by a user equipment, the method comprising:
determining that a parameter corresponding to a trigger event configuration is changed, and
disabling a trigger function of the trigger event.

2. The processing method according to claim 1, wherein the disabling the triggering function of the trigger event comprises at least one of:
stopping a reporting operation corresponding to the trigger event;
not performing the reporting operation corresponding to the trigger event; or
setting a state corresponding to the trigger event as being not fulfilled.

3. The processing method according to claim 1, wherein that the parameter corresponding to the trigger event configuration is changed comprises at least one of:
the parameter of the configuration is increased by an offset;
the parameter of the configuration is reduced by an offset;
the parameter of the configuration is multiplied by a scaling amount; or
the parameter of the configuration is divided by a scaling amount.

4. The processing method according to claim 3, wherein the parameter of the configuration comprises at least one of:
time to trigger, wherein the time to trigger is time for performing trigger according to setting of the trigger event;
a threshold value used to determine whether the trigger event is fulfilled;
the number of reporting a result corresponding to the trigger event; or
an interval for reporting the result corresponding to the trigger event.

5. The processing method according to claim 2, wherein the trigger event is a measurement reporting event, and stopping the reporting operation corresponding to the trigger event is at least one of:
stopping a periodic reporting timer corresponding to a measurement identity of the trigger event;
in a case where it is determined that preset indication information is configured, performing the reporting operation corresponding to the trigger event once, wherein the preset indication information is configured to indicate whether to perform the reporting operation corresponding to the trigger event once in a case where the configuration corresponding to the trigger event is changed;
deleting a measurement reporting entry corresponding to the measurement identity, or
deleting all or part of cells in a trigger cell list corresponding to the measurement identity.

6. The processing method according to claim 1, wherein the trigger event is a conditional reconfiguration event, and the conditional reconfiguration event is associated with a measurement identity.

7. The processing method according to claim 1, further comprising at least one of:
in a case where the user equipment fulfills a condition, using the trigger event according to original configuration of the trigger event;
in a case where the user equipment fulfills the condition, using the trigger event according to the changed configuration of the trigger event;
in a case where the user equipment does not fulfill the condition, using the trigger event according to the original configuration of the trigger event; or
in a case where the user equipment does not fulfill the condition, using the trigger event according to the changed configuration of the trigger event.

8. The processing method according to claim 7, wherein the condition is at least one of:
the user equipment is a low-speed user equipment,
the user equipment is a medium-speed user equipment
the user equipment is a high-speed user equipment;
a speed of the user equipment is greater than a first speed threshold;
the speed of the user equipment is less than a second speed threshold;
an altitude of the user equipment is higher than a first altitude threshold;
the altitude of the user equipment is lower than a second altitude threshold; or
the user equipment fulfills at least one set event.

9. The processing method according to claim 1, further comprising:
determining that triggering difficulty of the trigger event increases, and
disabling the trigger function of the trigger event.

10. The processing method according to claim 9, wherein the determining that the triggering difficulty of the trigger event increases comprises:
in a case where the parameter of the configuration being changed is time to trigger and the changed time to trigger is greater than the time to trigger before change, determining that the triggering difficulty of the trigger event increases.

11. The processing method according to claim 9, wherein the determining that the triggering difficulty of the trigger event increases comprises:
in a case where the parameter of the configuration being changed is a threshold value and the changed threshold value is greater than the threshold value before change, determining that the triggering difficulty of the trigger event increases.

12. A method for sending configuration information, performed by a network device, the method comprising:
sending configuration information to a user equipment, wherein the configuration information is configured to configure parameters corresponding to a trigger event configuration.

13-14. (canceled)

15. A communication device, comprising:
a processor; and
a memory configured to store a computer program,
wherein the processor is configured to:
determine that a parameter corresponding to a trigger event configuration is changed, and
disable a trigger function of the trigger event.

16. A communication device comprising
a processor; and
a memory is configured to store a computer program;, and
wherein the processor is configured to execute the computer program to implement the method according to claim 12.

17-19. (canceled)
